(19) United States
(12) Patent Application Publication
(10) Pub. No.: US 2005/0286863 A1
(43) Pub. Date: Dec. 29, 2005

(54) Reliable capture of digital video images for automated indexing, archiving and editing

(76) Inventor: Rolf Michael Howarth, Stratford-upon-Avon (GB)

Correspondence Address: ROLF M. HOWARTH, BROOKLAND, THE GREEN, SNITTERFIELD, STRATFORD-UPON-AVON, CV37 0JG, GB

(21) Appl. No.: 10/906,897

(22) Filed: Mar. 11, 2005

Related U.S. Application Data
(60) Provisional application No. 60/521,715, filed on Jun. 23, 2004.

(51) Int. Cl. H04N 5/76; G11B 27/02; G11B 27/00

(52) U.S. Cl. 386/52; 360/13

(57) ABSTRACT

Capture the video signal from a digital video tape by checking the timecode within each frame as its captured and using device control to retry if there are dropped frames or other errors, and to pause the tape if the computer is unable to process the frames at the rate at which they arrive. Perform indexing as the tape is captured, using difference in date and time of each frame to determine when a new clip or subject starts, and allow the user to enter logging notes and select highlights at the time of capture.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND OF THE INVENTION

Because of their low cost, compact size, and high quality, digital video cameras that record a video signal to tape using the DV standard are widely used by consumer and professional users alike. Computers can be used to capture or copy the digital video signal from tape to another storage medium such as hard disk for purposes such as editing, random access, conversion to another format, long term archiving, or duplication. Most modern computers come equipped both with IEEE 1394 interfaces for connecting to DV camcorders and with software for performing video capture. IEEE 1394, also known as FireWire or iLink, is a high speed serial data communication protocol and passes both data and control information.

DV devices (including camcorders and DV tape decks) adhering to the IEEE 1394 and related standards support a standard protocol known as AV/C whereby the computer (or other controller on the IEEE 1394 bus) can query the current tape position of the device and can instruct the tape transport mechanism of the device to rewind, play, pause, fast forward and so on. Whenever the tape head is loaded (ie. the DV device is in “play” or “pause” mode) it transmits the video signal from the portion of tape lying under the tape head over the IEEE 1394 bus. This signal is sent in digital form, an exact digital copy of the video data that is stored in digital form on the tape.

DV is a standard for encoding video and audio signal at a constant data rate. Each DV frame is self-contained and does not depend on other frames to be decoded to a video image. One frame consists of 150,000 bytes (PAL) or 120,000 bytes (NTSC) of data and encodes both the video signal (at 720×576 25 fps PAL, or 720×480 30 fps NTSC) and the audio signal, plus additional metadata. This metadata includes a description of the format (flags to indicate frame size, PAL or NTSC, audio sample rate and bit depth, 4:3 or 16:9 aspect ratio, etc.) and a unique incrementing timecode value for each frame. The metadata can also include optional information such as the date and time of recording of the frame, the camera exposure details (aperture, shutter, gain, white balance), and start/stop bits to indicate the first and last frame of a shot (ie. when the camera started or stopped recording). This metadata information is specified by the camera at the time of recording and is encoded digitally within each frame, both as it is stored on tape and when it is played back over the IEEE 1394 FireWire bus.

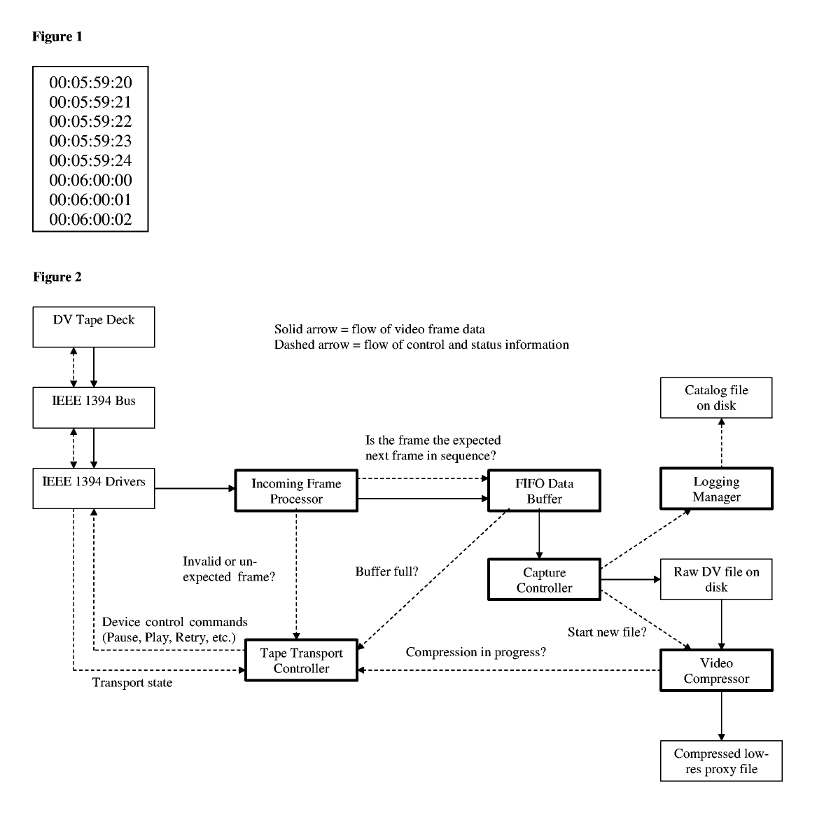

Each frame on a DV tape has a unique timecode value according to the SMPTE timecode scheme, consisting of hours:minutes:seconds:frames values, such as 00:12:59:24. These timecode values typically start at 00:00:00:00 at the beginning of the tape and increment sequentially, one frame at a time, to the end of the recording (FIG. 1).

A particular frame of video footage stored on a DV tape can therefore be identified uniquely by the combination of a unique tape name or number plus a timecode value. If the recording on the tape has gaps, however, then it is possible that the timecode sequence will start again from zero, resulting in duplicated timecode values, in which case it is necessary to supplement the tape name with the number of the sequence to maintain a unique identifier for each frame.

The AV/C control protocol provides information on the current timecode position of the tape that is being played back. However, the control protocol and the data stream are processed independently using different mechanisms and processing paths and there may be a small discrepancy from one to the other. For example, the video data for one frame (which might take 1/25^{th} or 1/30^{th} of a second to play back) may be read into a temporary buffer within the tape deck one bit at a time until it is complete and then re-transmitted as one block of 120 or 150 KB. Also, when sending a command to control the tape deck, such as “pause”, or “step forward to the next frame”, or “rewind (to the start of the tape)”, there will inevitably be some latency before the tape physically starts moving in response to that command, and a further delay before the video data for the next frame is sent once the tape starts playing. The discrepancy in timecode being reported via the control protocol and of the frame actually being received will vary from device to device and capture software typically has a learning mode or requires the user to enter a setting so that an appropriate corrective offset can be applied.

During the typical capture process, the computer will instruct the tape to start playing and will then record the video frames to hard disk as they arrive over the IEEE 1394 interface and driver software. Details of the IEEE 1394 interface or of the low level driver software works is not important to this description. The software drivers are normally provided by the manufacturer of the computer's FireWire interface card or as a standard part of the computer operating system.

Once the tape starts playing it plays at a constant speed and so the data arrives at a constant rate of around 3.5 megabytes/second. During capture, if the computer is unable to record this data to disk as fast as it arrives then so-called “dropped frame” errors may occur. Out of necessity, one or more complete frames may be omitted from the video file that is written to disk. Depending on the implementation, the duration of the frames that are recorded is adjusted to maintain the appropriate overall duration (e.g. certain frames are doubled up) or the duration of the resulting video file is shorter than it ought to be. It is still possible to play back such a video file from the computer's hard disk but there will be problems with it: there may be stutters or jumps in the played back image; there may be synchronisation discrepancies between the audio and video tracks (as these are usually processed and recorded via slightly different processing paths); or incorrect timecode values may be recorded for the start or end of the file. Such dropped frames can cause particular problems during video editing where accuracy down to an individual frame is required. Accurate timecode is necessary to permit precise calculation of durations and so that two or more video clips (or video clips and audio clips) can be matched up precisely.

The integrity of the captured video files is also affected by errors in playback or transmission. Because the source of the video signal is a physical tape and deck with moving parts it is possible that the data being captured may have errors where the bits differ from those originally recorded on the tape. Capture errors might be caused by various factors, such as tape dropouts, dirt on the playback head, tape sticking or slipping, electrical interference on the IEEE 1394 cable during transfer, and so on. Synchronisation and error correction mechanisms exist in both the tape deck and in the IEEE 1394 interface and driver software to ensure that only well-formed frames of the appropriate size (120 or 150 KB) are received by the capture software but the sequence of frames received may have omissions, duplications, or contain frames with incorrect or jumbled up data (such as portions of one frame intermingled with those of another.

The video signal may be stored on disk in a variety of formats. In the simplest case, it is captured in raw DV format. This is a digital copy of the signal as it is stored on tape with little or no further processing (the audio track may be decoded and stored separately for convenience during playback, and the particular file format used such as QuickTime may provide an additional “wrapper” around the data, but the video frame data itself is unaltered). This format is well suited for video editing, as there is no further loss in quality due to compression and the final edited program needs to be in DV format to write it back to DV tape. However, the DV format is not very highly compressed and requires a large amount of hard disk space for storage, making it unsuitable for long-term on-line storage.

One solution to the storage requirements problem is to copy the DV format files to off-line storage such as an external hard drive or a removable tape or optical disc drive. External and removable drives are generally much slower than a computer's internal hard drive, however, and may not keep up with the high data rate of incoming DV frames. It may be necessary to capture to the internal hard drive first and then copy the file to the external storage media and finally delete the file from the internal disk. This operation needs to be performed manually by the user and is likely to be both time consuming and prevent the computer from being used for anything else.

Another solution is to reduce the data size by re-compressing the raw DV video signal, either at a lower resolution (spatially or temporally), using a more efficient video codec, or both. Reducing the size of the files allows more of them to be stored on the hard disk. These re-compressed files can be used as an editing “proxy”, permitting the editor to make an edit decision list consisting of the timecode values of the start and end of each video clip to be used. To create the final edited program the original DV tape(s) can be loaded in the tape deck and the non-linear editing system will automatically control the deck to recapture the required clips based on the timecode values in the edit decision list, this time at full quality DV format. This process is known as batch capture. (This contrasts with a linear editing system, which controls both a source and destination tape deck and directly copies portions of the tape from source to destination based on the edit decision list.)

Typically, re-compressing the video signal is a very time consuming process and cannot be done in real-time as the video signal is being captured, especially if video codecs are used that try to maximise both the compression ratio and quality (such as MPEG-4, Sorenson Video 3, or Windows Media 9). It is necessary to capture the entire signal to disk first using the DV format and then to perform the compression as a separate step. This requires additional disk space (to maintain both “raw” and compressed versions of the signal) and ties up the computer for a long period at the end of the capture until the compression processing completes.

The process of viewing the video signal recorded on a tape to identify the start and end of a shot or clip, annotating a clip with a name or notes describing the subject or particular features of the clip, and deciding which clips to include in an edited program, is known as logging and can be very time consuming. The start/stop bit metadata within DV frames enable the capture software to identify the start of each new recording made by the camera and then automatically start a new file at that point so each shot is captured to a separate file. This can aid logging, if the user captures to disk first and then views the separate files representing separate shots, but means the user cannot start logging until a whole tape has been captured. An alternative approach is to log from the tape, by fast forwarding and rewinding, playing and viewing the tape, and marking the appropriate points to capture as the tape plays, but this requires the tape to be played a second time to perform the actual capture.

If the user (for example, a video editor or producer) has a large number of tapes to deal with and logs the entire tape in each case then the information entered during logging may be collected together to form a catalog or index of the tape or tapes, possibly including a thumbnail image of each shot or clip and a reference to the captured file (whether in DV format or a low-resolution proxy). This index can be saved to a file and kept as a useful archival record of the tape even if the captured video file(s) are subsequently deleted to free up disk space. Batch capture can then be used to recapture the video files subsequently.

Another common way to archive a DV tape is to copy the video signal to a DVD (digital versatile disc). This is especially useful for consumer users, as it allows them to view their family videos using a domestic DVD player and television set. To allow rapid access to particular portions of the disc chapter markers and a navigation menu may be placed on the disc. These could be specified manually at the time the disc is produced or determined automatically based on the recording date metadata (one for each new date). To improve the viewing experience it is usually desirable to edit the video footage that was originally recorded on the tape to select the interesting highlights prior to copying the material to DVD, but this editing process takes considerable time and is often omitted by consumers when making a DVD.

### BRIEF SUMMARY OF THE INVENTION

The present invention is concerned with the reliable and time efficient transfer and capture of a video signal from a camcorder to a computer for subsequent editing and archiving.

The prior art can be seen to exhibit a number of problems:
(1) Dropping frames during capture
(2) Errors in the captured file due to tape dropouts, electrical interference, etc. occurring during capture
(3) Inability to capture to slow (external or removable) storage media
(4) Inefficient use of hard disk space through need to capture an entire tape in DV format prior to recompressing, and time spent at end of capture to perform the recompression
(5) Extra time required and/or extra wear on tape if logging and capture are carried out as two separate steps
(6) Manual intervention required to select and organise clips and create navigation system when preparing an archival copy of a tape (eg. to DVD)

All of these problems, separately or in combination, are addressed by the present invention, a video capture device with a number of innovative features.

In summary:
(1) The frame data to be captured is monitored as it is received from the tape and if an error is detected the camera or deck is instructed to rewind and retry playback of the offending frame.
(2) Data is written to disk via a fast, in-memory first in, first out buffer.
(3) If writing the data to disk is too slow and the FIFO buffer fills up the tape is paused to prevent any data from being lost.
(4) A second level of buffering is implemented via the file system, by first writing the raw data to disk and then compressing it as a background process.
(5) Finally, the video signal is analysed into separate clips and clips identified so far are presented to the user while the capture progresses, allowing them to enter logging comments and build up a tape index during the capture.
(6) Automatic grouping of related clips during capture aids the automatic generation of archival recordings.

### BRIEF DESCRIPTION OF THE SEVERAL VIEWS OF THE DRAWING

FIG. 1 Example of incrementing timecode sequence
This diagram shows an example of the expected SMPTE timecode sequence of a PAL video signal with 8 consecutive frames around the 6 minute mark.

FIG. 2. System overview
This diagram is a system block diagram of the main logical components of the invention, showing the flow of data from tape to disk and the flow of control between the components.

### DETAILED DESCRIPTION OF THE INVENTION

In the preferred embodiment of the present invention a personal computer with built-in IEEE 1394 interface and driver software is used. A DV tape deck or camcorder is connected to the computer by means of an IEEE 1394 cable. The personal computer has other standard features that one would reasonably expect: a display, keyboard or other input device, memory, disk storage, an operating system, and the ability to run a stored program of instructions. The computer is configured to run a stored program known as the Capture Software.

The Capture Software consists of 6 main logical components: Incoming Frame Processor, FIFO Data Buffer, Tape Transport Controller, Capture Controller, Logging Manager, and Video Compressor (FIG. 2).

The IEEE 1394 software drivers are configured to pass incoming DV frame data to a software procedure (the Incoming Frame Processor) within the Capture Software rather than to capture directly to a file. The Incoming Frame Processor receives incoming DV frame data, processes this data, and passes it on to other components in a specified manner. The data received by the Incoming Frame Processor, and by the FIFO Data Buffer and Capture Controller, is always a complete, fixed size, block of 120 KB or 150 KB representing one frame of raw DV video at a time.

The Incoming Frame Processor decodes the timecode value encoded in the DV frame data and also performs error checking on the frame itself. If the frame is error free and its timecode has the expected value the frame is stored in a first-in, first-out (FIFO) Data Buffer. Frames arrive at the Incoming Frame Processor at a constant “real-time” rate as they are played off the DV tape and need to be processed as quickly as possible to minimise the likelihood of dropping any frames. The FIFO Data Buffer is implemented in the processor's main memory and writing to the data buffer is therefore a fast operation.

A separate component, the Capture Controller, receives frame data from the FIFO Data Buffer and writes it to a file on disk. The process of writing the raw DV file to disk is therefore decoupled from the Incoming Frame Processor via the FIFO Data Buffer. If writing a particular frame to disk takes too long (for example, because the drive needs to seek to another portion of the disk, or another process on the computer is using the hard drive) this will not block the Incoming Frame Processor, causing the next incoming frame to be dropped.

This configuration even works if the storage medium the data is being written to is consistently too slow for DV data rates, for example if the medium is a slow external or removable drive. Raw DV data is written to the drive as fast as the drive is capable of doing, while the FIFO Data Buffer slowly fills up (at a rate which is the difference between the rate of incoming data and the rate at which it can be written to disk). The FIFO Data Buffer has a particular capacity (which may be a fixed pre-determined amount or be governed by how much free memory the computer has available). If this capacity is reached the buffer is full and the Tape Transport Controller is notified. The Tape Transport Controller issues an AV/C device control command over the IEEE 1394 bus to pause the tape that is being played and therefore suspend sending new video frame data to the Incoming Frame Processor, thereby giving the Capture Controller the opportunity to write the raw DV data to disk and empty the FIFO Data Buffer. Once the buffer has been emptied, the Tape Transport Controller instructs the tape to continue playing and resume sending video frame data.

Typically it will take a short time before the DV tape deck responds to an AV/C command and so it may continue to send video frame data for some time even after the command to pause the tape has been sent by the Tape Transport Controller. Because of this latency, the command to pause the tape is actually sent when the FIFO Data Buffer approaches but has not yet reached its maximum capacity. Likewise, to maximise throughput, the command to resume playing is sent when the buffer is nearly but not completely empty.

As has already been mentioned, the Incoming Frame Processor analyses incoming DV frames as they arrive to read the timecode encoded in the frame. The following processing is performed:

1. When starting a capture, frames are first written to a temporary buffer until a sequence of N consecutive frames with consecutive SMTPE timecode values is received (where N is a small constant integer). At this point, those frames are passed on the FIFO Data Buffer and normal processing resumes. If a frame that does not have the correct (consecutive, as per FIG. 1) timecode value appears then the count restarts from zero. The purpose of this start up check is to ensure that a stable sequence is being received (the tape has reached its correct playing speed and any earlier frames that may have been buffered by the tape deck or IEEE 1394 driver software have been cleared through the system). If the start up sequence does not successfully complete within a timeout period an error is reported and the capture is aborted.

2. During normal processing, each incoming frame's timecode is compared with that of the last frame to have been sent on to the FIFO Data Buffer. If it is the next value in the sequence, the frame is added to the FIFO Data Buffer.

3. When a tape is paused the deck typically sends the same frame repeatedly, so if the incoming frame's timecode value is the same as the last frame, it is simply discarded.

4. If any other value is received (neither the same timecode as the last frame nor one frame later) the frame is stored in a temporary buffer, a flag is set and the following incoming frame is awaited:
a) If the following frame has the expected timecode value (last good frame plus one) it is passed on to the FIFO Data Buffer, the intervening frame is discarded as being a temporary aberration, and the process continues normally.
b) If the following frame follows on sequentially from the intervening frame, and there is a significant jump in timecode from the last good frame written to the FIFO Data Buffer then this is assumed to indicate the start of a new timecode sequence (i.e. a timecode reset) and both the intervening and following frame are written to the FIFO Data Buffer and processing continues normally.
c) If the intervening and following frame do not follow on from the last good frame and do not indicate the start of a new sequence then the Incoming Frame Processor instructs the Tape Transport Controller to attempt to retry by rewinding the tape to a point a few seconds before the error occurred and then resuming playing. Frames are ignored until the expected frame is reached, at which point processing continues normally.

Each frame has the timecode encoded within it in a number of places. By checking that these different copies of the timecode agree with each other and by performing other checks to ensure that the frame of data has the correct internal structure it is possible to determine whether the frame was received without error or not. A frame which appears to have errors, or where the timecode cannot be read reliably, is treated as if it is out of sequence with respect to the previous one, and hence initiates a retry as per step 4 c).

This description of the process is simplified and illustrative only and further cases are handled, for example to recover from longer aberrations as per step 4 a), or for dealing with errors that persist after retrying, such as might follow from a damaged tape or errors that occurred within the camera at the time of recording.

The Capture Controller thus receives a stream of video frames that has already had errors corrected. It then analyses the metadata in each frame to decide how to further process it as follows. In the normal case, if the timecode of the frame follows on sequentially from the preceding one, it is appended to the current raw capture file on disk. If the timecode is not sequential this indicates the start of a new timecode sequence and so the current file is closed, a new capture file is opened, and a new tape identifier is assumed. If the start/stop recording bits in the metadata indicate that this frame is the start of a new shot then likewise, a new capture file is opened. Other conditions might also trigger switching over to a new file, for example if a preset file size limit is reached, or if the current capture volume is full and capture should continue on a different file volume.

When a raw capture file is closed (and a new capture file is opened, assuming the end of the capture has not yet been reached) the raw capture file is added to a queue of files to be compressed by the Video Compressor. The Video Compressor is a separate process (running on the same or a different processor from the Capture Controller) that converts the DV video signal in a raw capture file into an alternative form, such as MPEG-4. Once the raw capture file has been re-encoded, the original raw capture file may be deleted from disk to make space for further data. If a compression is already in progress and there are too many raw capture files in the queue awaiting compression then the Video Compressor may signal to the Tape Transport Controller requesting that it pause the tape until the current compression completes, in exactly an analogous way to what happens when the FIFO Data Buffer is full. In this way the resources consumed (both memory and disk space) can be limited.

The Capture Controller also communicates with and passes frame data to a Logging Manager. The Logging Manager constructs an index of the clips on the tape that is being played. Each time an “interesting event” in the incoming video frames is detected the timecode value of that frame is recorded to indicate the start of a new clip, together with the metadata and a thumbnail image for that frame (or a subsequent frame). Interesting events might include the presence of the start/stop recording marker bits in the frame, a sudden jump in the recording date or other metadata, or a jump in the audio volume or visual content of the frames (visual scene detection). It could be indicated by the presence of an audio marker, such as a tone of a particular frequency or the snap of a clapper board. An interesting event might also be indicated by the user manually monitoring the video signal from the tape deck and pressing a key on the keyboard or other input device at a particular point of interest.

The Logging Manager maintains a list of all the clips detected so far within the current capture session. As the capture progresses, more clips will be added to the list in real time. A user operating the computer can select any of these clips, either the current clip that is being captured at the present time or an earlier clip, and view the thumbnail, metadata (such as timecode or recording date), and play back the compressed or raw video file for that clip (as appropriate) on the computer display screen. For the current clip, the user can monitor the live video signal that is being transmitted from the tape deck. Based on this information, the user can type in a description or keywords relating to the clip, and can rate it as being a good clip or not. The user can also mark additional event points within the clip. In this way, the user can log his or her clips while the capture progresses, thus saving time. The user can also take a break at any time, leaving the capture and compression to progress, then come back later and log the intervening clips. Upon completion of the logging process a catalog or index of the clips captured is saved to a file on disk. This index file contains the thumbnails, metadata, and text entered by the user and is then available for subsequent retrieval, including viewing and searching, as a record of the contents of a tape, irrespective of whether or not the captured or compressed video files are still available.

A particular feature of the Logging Manager is the ability to automatically group related clips by subject during logging. Each clip record has associated with it a “subject”. Consecutive clips will belong to the same subject unless the user chooses to create a new subject, in which case the new subject applies to the selected and subsequent clips. If the user types in a name for a subject it is applied to all clips sharing that subject. The user can also apply a subject from an earlier clip to the selected and subsequent clips. The Logging Manager monitors the recording date metadata as it creates each new clip and if there is a jump of more than a specified interval, such as 2 hours, in the recording date the Logging Manager automatically starts a new subject at that point. (Note that even though this metadata is commonly referred to as the recording date, it actually includes both a date and time stamp). This feature is especially useful for consumers, who tend to record many different occasions on one tape, such as a child's birthday, a particular outing, and so on. Being able to automatically group all the clips together that relate to one occasion or subject is a very useful feature. Monitoring the interval between the recording date and time of consecutive clips is more accurate than grouping into bins based on date alone as material recorded around the time when the camera's clock is showing midnight on a particular day might otherwise be separated even though they belong to the same occasion.

Finally, by combining all the index information (collected both automatically and as a result of user input during the logging process), it is possible to automatically generate an edited program or multimedia presentation of the captured material. This can include titles, if required for a non-interactive medium such as tape, or navigation to particular portions of the program, for output to interactive media such as a DVD or web page.

In the simplest case, all those clips that the user marked as good (or alternatively, did not explicitly mark as “not good”) are assembled into separate sequences or segments, one for each “subject”. Each segment has as its title the name of the subject. For DVDs, each subject segment has a chapter marker and one (or more, depending on how many subjects there are) navigation menu(s) are generated, listing the subjects and allowing navigation straight to the relevant segment. By default, the menu(s) might show a thumbnail, the subject name, and recording date for each segment.

In a more complex scenario, the user might want to automatically edit the program by trimming material off the beginning or end of long clips to produce a shorter, more interesting DVD and a more pleasurable experience for viewers (especially for friends or family members forced to watch the DVD!).

To support automatic editing, the type of logging information that the user can enter is extended beyond that described previously. The objective is to make it is as easy as possible for the user to enter information useful for editing in a single pass while watching the video signal, through particular key combinations or other forms of input, including both a rating or degree of “goodness” and a way of marking events. For example, pressing the ‘G’ key once might mark the current clip as good generally, while pressing ‘G’ twice in quick succession might indicate a particularly interesting event that should be included at all costs. Pressing ‘B’ might indicate that the beginning of the clip should be favoured, while ‘E’ indicates the end should be used, and so on.

If the user inputs a target duration for the edited program, the invention can then automatically perform editing using the information available and a variety of heuristic rules. For example, “pick good clips first, then others to make up the required duration”, or “select a longer scene at the start of a new subject (to set the scene), then trim subsequent scenes”. Such automated editing can never be perfect of course, and the user has the opportunity to manually refine the editing if he or she wishes. The quality of results depends on how much effort the user is willing to put in during the logging process but allowing the user to make rough edit decisions in a single pass, at the same time as capturing, can provide a great saving in time over traditional editing methods. Making the editing process quicker and easier for consumers is likely to be the only way of ensuring that is it is done and thus tackling the common issue of ever more material being recorded but never being watched.

Variations in the precise functioning of the invention can be specified by the user according to their requirements or preferences or be provided by different versions of the application software. The destination drive where raw DV data is written can be any file volume accessible to the computer, including internal hard disk drive, external hard disk drive, a network volume, or external removable media. Rather than capturing at full frame rate the user may choose to capture at a reduced frame rate such as 12 or 15 fps to reduce the amount of storage space that is required, or the user may choose to capture at a very much reduced frame rate such as 1 frame every 30 seconds to create a time-lapse motion recording. The user may specify any video compression format supported directly by the capture software or provided via operating system library calls, or they may choose to omit the video compression stage entirely and use the raw DV files directly. They may choose whether to compress the raw DV files incrementally or capture an entire tape first and then compress the files later. Whether to start a new file for each shot, create files of fixed duration, or create one file for the capture of an entire tape can be specified. The behaviour of the error and dropped frame correction can be configured, for example whether to retry if errors are detected, how many times to retry, and whether to abort a capture if unrecoverable errors are encountered or to continue capturing the rest of tape. Which portion(s) of the tape should be captured can be specified, for example the software can be instructed to rewind to the start and capture an entire tape until the end is reached, or it could accept a list of start and end timecode values and capture frames between those values only. The user might also decide whether or not to perform logging at the same time as capturing, and the invention might or might not allow playback or further processing of either the raw or compressed video files while capture or logging are in progress or as a separate step.

The above description is not intended to be exhaustive and other variations and embodiments of the invention obvious to one skilled in the art are similarly claimed. In particular, the same principal can apply to recording formats that contain metadata other than DV and to other transport protocols than IEEE 1394.

1. An apparatus for transferring a video signal from one device to another, comprising:
a source of video signals comprising a sequence of numbered frames that are transmitted in sequential order,
a receiver that receives the video signals from the source,
a means whereby the receiver can control the source of the video signals,
a medium for recording the signals received by the receiver,
a means of monitoring the sequence numbers of frames that are received by the receiver to verify that frames are received in the order they are expected and as a complete sequence.

2. The apparatus of claim 1, together with a means of recording only those frames to the recording medium which arrive in the expected order and discarding any unexpected frames.

3. The apparatus of claim 1, together with a means of requesting that the source of video signals re-transmit the sequence of numbered frames from a point before the last expected frame if unexpected frames are detected.

4. An apparatus for transferring a video signal from one device to another, comprising:
a source of video signals comprising a sequence of frames that are transmitted in sequential order,
a receiver that receives the video signals from the source,
a means whereby the receiver can control the source of the video signals,
a medium for recording the signals received by the receiver,
a means of requesting that the source temporarily suspends transmission of video frames if frames are received faster than the receiver or the recording medium can process the frames.

5. The apparatus of claim 4, together with a buffer that stores the frames that are received from the video source prior to recording those frames to the recording medium and a means of requesting that the source temporarily suspends transmission of video frames if the buffer is approaching its maximum capacity.

6. A video capture device comprising the apparatus of either claim 1 or 4 or of both in combination.

7. The apparatus of claim 6, together with a mechanism for monitoring the integrity of the frames received by the receiver and a means of requesting, if a transmission error is detected, that the source of video signals re-transmit the sequence of frames from a point before the last error-free frame.

8. The apparatus of claim 6, together with a means of compressing the video signal or converting it to another alternative form and then storing the compressed or converted form on the recording medium.

9. The apparatus of claim 6, together with a means of specifying which frames are to be stored by providing a list of frame numbers or ranges of frame numbers and controlling the video source to transmit those frames.

10. The apparatus of claim 6, where the source of the video signal is a video camera/recorder or video tape deck playing back a tape on which a sequence of video frames has been recorded.

11. The apparatus of claim 6, where the receiver is an electronic computer.

12. The apparatus of claim 6, where the medium for recording the signals received by the receiver is a hard disk drive.

13. The apparatus of claim 6, where the medium for recording the signals received by the receiver is an external or removable drive or a network volume.

14. The apparatus of claim 6, where the video frames are encoded using the DV encoding standard and the sequence numbers are timecode values stored within each frame.

15. An apparatus for transferring a video signal from one device to another, comprising:
a source of video signals comprising a sequence of frames that are transmitted in sequential order,
a receiver that receives the video signals from the source,
a medium for recording the signals received by the receiver,
a means of creating and storing an index of the video signals, separate from the signals, as the signals are received from the source.

16. The apparatus of claim 15, where the index stores the frame number of those frames that belong to a set of contiguous mutually related frames (known as a clip) together with additional information relating to each clip.

17. The apparatus of claim 16, where the additional information includes a full-size or scaled down image of one or more frames of each clip.

18. The apparatus of claim 16, where the additional information includes any date and time information encoded within the video signal transmitted by the source.

19. The apparatus of claim 15, together with a means of monitoring one or more properties of each frame as it is received and automatically creating the index by starting a new clip at that frame where a change of sufficient magnitude in one or more of the properties being monitored occurs.

20. The apparatus of claim 19, where one of the properties being monitored is the date and time encoded within the frame or transmitted with it.

21. The apparatus of claim 19, where one of the properties being monitored is the presence or absence of a start of recording marker encoded in each frame.

22. The apparatus of claim 19, where each frame of the video signal is encoded as or converted to a set of numerical pixel values and one of the properties being monitored is a mathematical function of the numerical pixel values of the current frame or of the current frame and the preceding one.

23. The apparatus of claim 19, together with a means of organising and grouping related clips in the index based on whether the change in one of the frame properties being monitored between the last frame of one clip and the first frame of the next clip exceeds some threshold (different to that used to determine clip boundaries).

24. The apparatus of claim 23, together with a video playback device that uses the recorded video signal and index to permit playback of individual clips or groups of related clips.

25. The apparatus of claim 24, where the recorded signal is copied to a Digital Versatile Disc and the contents of the index are used to automate the generation of disc navigation menus and chapter markers.

26. The apparatus of claim 16, together with a means of displaying the video signal to the operator, either as it is being transmitted from source to receiver or by playing back the recorded signal from the recording medium, and a means for the operator to input data, and where the additional information for a given clip includes any data entered by the operator as the frames for that clip were displayed to the operator.

27. The apparatus of claim 26, where the data that may be input by the operator includes: a name or other textual description, a rating for the clip as a whole, or marking one or more specific frames within the set of frames comprising a clip.

28. The apparatus of claim 27, together with a means of generating an edited subset of the set of frames recorded by automatically selecting clips or portions of clips that have a high rating or that have been marked until a desired duration is reached.
